(19) United States
(12) Patent Application Publication
(10) Pub. No.: US 2019/0298099 A1
(43) Pub. Date: Oct. 3, 2019

(54) SYSTEM FOR CONTROLLING THE TEMPERATURE LEVEL OF A HEATED PLATEN

(71) Applicant: A. J. ANTUNES & CO, Carol Stream, IL (US)

(72) Inventors: JAMES BUCHLER, Orland Park, IL (US); Joseph Frankiewicz, Schaumburg, IL (US)

(21) Appl. No.: 16/297,608

(22) Filed: Mar. 9, 2019

Related U.S. Application Data
(60) Provisional application No. 62/649,011, filed on Mar. 28, 2018.

(51) Int. Cl. A47J 27/04; F22B 1/28; A47J 36/32

(52) U.S. Cl. CPC A47J 27/04; A47J 2027/043; A47J 36/32; F22B 1/288

(57) ABSTRACT

A flash steamer water control system for use in connection with the flash-steam cooking of food items comprises a heated platen, an electric power supply for supplying electrical power to the heated platen, a water discharge mechanism for discharging water onto the heated platen such that the water discharged onto the heated platen will be flashed into steam, and a control system operatively connected to the water discharge mechanism for controlling the water discharge mechanism so as to permit the water discharge mechanism to discharge water onto the heated platen only when the temperature level of the heated platen is at or above a predetermined temperature level so as to effectively guarantee that the water, discharged from the water discharge mechanism onto the heated platen, will be flashed into steam throughout a predeterminedly timed flash-steamed cooking cycle without overwhelming the heated platen and flooding the same.

### CROSS REFERENCE TO RELATED APPLICATIONS

The present invention is a non-provisional patent application which is effectively a non-provisional patent application conversion from U.S. Provisional Patent Application, Application No. 62/649,011 which was filed in the United States Patent Office on Mar. 28, 2018, and from which the priority benefits of which are hereby claimed.

### FIELD OF THE INVENTION

The present invention relates generally to food service equipment, and more particularly to a system for controlling the temperature level of a heated platen, which is used within flash steamer cooking apparatus for cooking food products by flash steaming techniques, by controlling the timed discharge of water onto the heated platen.

### BACKGROUND OF THE INVENTION

In conventional flash steamer cooking apparatus for cooking foods by flash steaming techniques, water is sprayed onto a heated platen or surface which has an ideal temperature of 400° F. As the water encounters the heated platen or surface, the water will immediately undergo a physical transition into steam and the temperature level of the heated platen or surface will be significantly reduced. In turn, as the temperature of the heated platen or surface continues to be reduced, it takes longer to flash off additional water into steam. However, the water controller, which controls the burst or pulse of water, being discharged from a suitable source of water and onto the heated platen or surface, continues to discharge the water in accordance with its pre-programmed periodic water discharge cycle. Eventually, the heated platen or surface cannot effectively convert the water into steam sufficiently fast so as to effectively maintain the water-steam cycle, and is ultimately overwhelmed with water whereby the flash steamer cooking apparatus no longer produces steam, is flooded with water, and the flash-steaming cooking of the food items is compromised.

A need therefore exists in the art for a new and improved flash steamer cooking apparatus. Another need exists in the art for a new and improved flash steamer cooking apparatus wherein the cyclic discharge of sprayed water onto a heated platen, so as to effectively convert the sprayed water into steam, is maintained. Still another need exists in the art for a new and improved flash steamer cooking apparatus wherein the cyclic discharge of sprayed water onto a heated platen, so as to effectively convert the sprayed water into steam, is maintained over a predetermined period of time so as to in fact complete a flash steam cooking cycle for preparing food items by flash steaming techniques. Yet another need exists in the art for a new and improved flash steamer cooking apparatus wherein the cyclic discharge of sprayed water onto a heated platen, so as to effectively convert the sprayed water into steam, is maintained over a predetermined period of time so as to in fact complete a flash steam cooking cycle for preparing food items by flash steaming techniques without the heated platen being overwhelmed with water and thereby becoming flooded. Still yet another need exists in the art for a new and improved flash steamer cooking apparatus wherein the cyclic discharge of sprayed water onto a heated platen, so as to effectively convert the sprayed water into steam, is automatically maintained over a predetermined period of time so as to in fact complete a flash steam cooking cycle for preparing food items by flash steaming techniques without the heated platen being overwhelmed with water and thereby becoming flooded and without any monitoring of the system. Yet still another need exists in the art for a new and improved flash steamer cooking apparatus wherein the cyclic discharge of sprayed water onto a heated platen, so as to effectively convert the sprayed water into steam, is automatically maintained over a predetermined period of time so as to in fact complete a flash steam cooking cycle for preparing food items by flash steaming techniques without the heated platen being overwhelmed with water and thereby becoming flooded, and wherein the only required input into the system is the setting of the cooking time.

### OVERALL OBJECTIVES OF THE INVENTION

An overall objective of the present invention is to provide a new and improved flash steamer cooking apparatus. Another overall objective of the present invention is to provide a new and improved flash steamer cooking apparatus wherein the cyclic discharge of sprayed water onto a heated platen, so as to effectively convert the sprayed water into steam, is maintained. Still another overall objective of the present invention is to provide a new and improved flash steamer cooking apparatus wherein the cyclic discharge of sprayed water onto a heated platen, so as to effectively convert the sprayed water into steam, is maintained over a predetermined period of time so as to in fact complete a flash steam cooking cycle for preparing food items by flash steaming techniques. Yet another overall objective of the present invention is to provide a new and improved flash steamer cooking apparatus wherein the cyclic discharge of sprayed water onto a heated platen, so as to effectively convert the sprayed water into steam, is maintained over a predetermined period of time so as to in fact complete a flash steam cooking cycle for preparing food items by flash steaming techniques without the heated platen being overwhelmed with water and thereby becoming flooded. Still yet another overall objective of the present invention is to provide a new and improved flash steamer cooking apparatus wherein the cyclic discharge of sprayed water onto a heated platen, so as to effectively convert the sprayed water into steam, is automatically maintained over a predetermined period of time so as to in fact complete a flash steam cooking cycle for preparing food items by flash steaming techniques without the heated platen being overwhelmed with water and thereby becoming flooded and without any monitoring of the system. Yet still another overall objective of the present invention is to provide a new and improved flash steamer cooking apparatus wherein the cyclic discharge of sprayed water onto a heated platen, so as to effectively convert the sprayed water into steam, is automatically maintained over a predetermined period of time so as to in fact complete a flash steam cooking cycle for preparing food items by flash steaming techniques without the heated platen being overwhelmed with water and thereby becoming flooded, and wherein the only required input into the system is the setting of the cooking time.

### SUMMARY OF THE INVENTION

In accordance with the principles and teachings of the present invention, there is disclosed a new and improved system for controlling the temperature level of a heated platen in a flash steamer cooking apparatus in order to improve the cyclic water-steam operation. More particularly, it has been noted that when water is sprayed onto a heated platen, it is immediately flashed into steam with the adjunct result that the temperature level of the heated platen will be significantly reduced. If the temperature level drops below a predetermined temperature level, such as, for example, 300° F. or 350° F., a sufficient amount of water will not in fact be capable of being flash-steamed whereby, not only will the desired cooking of the food items be compromised but, in addition, the heated platen will effectively be overwhelmed by the water, which is constantly being sprayed onto the heated platen in accordance with a predetermined or pre-programmed water discharge cycle, and will thereby be flooded so as to no longer be capable of achieving flash-steaming.

Therefore, in accordance then with the principles and teachings of the present invention, the timed discharge of water sprayed onto the heated platen is therefore controlled in accordance with temperature data signals derived from the heated platen. The temperature data signals are derived from the heated platen by means of a temperature sensor and are reflective of the thermal energy stored within the heated platen as well as the fact that electrical power is constantly being supplied to the heating elements of the heated platen in a controlled manner so as to heat the same to a desired predetermined level, such as, for example, 400° F., which is the desired temperature level of the heated platen at the beginning of a flash-steamed cooking cycle when the largest amount of steam is to be flashed from the sprayed water in order to rapidly heat the food item and thereby begin cooking the same. Accordingly, at the beginning of a flash-steam cooking cycle, a first controller will control the heating elements of the heated platen, and the temperature sensor will transmit a signal to a second controller which is provided in conjunction with a water discharge mechanism for controlling the water discharge mechanism in order to permit the water discharge mechanism to discharge water onto the heated platen in, for example, a predeterminedly configured sprayed pattern. The discharge of the water onto the heated platen will of course tend to reduce the temperature level of the heated platen, however, the first controller, operatively associated with the heating elements of the heated platen, will control the electrical power delivered to the heating elements of the heated platen so as to tend to elevate the temperature level of the heated platen to a temperature level of at least 300° F. or 350° F. and thereby ensure that water, discharged from the water discharge mechanism and onto the heated platen, will in fact be flash-steamed in order to achieve the complete flash-steaming of the particular food items to be cooked. This temperature level of at least 300° F. or 350° F. is maintained throughout the cooking cycle, which is predeterminedly timed for a particular food item to be cooked, as a result of the first controller tending to constantly elevate the temperature of the heated platen by controlling the electrical power delivered to the heating elements of the heated platen while, at the same time, the second controller controls the water discharge mechanism, in order to spray water onto the heated platen, in accordance with temperature level signals transmitted from the temperature sensor.

At the conclusion of the timed cooking cycle, a signal is transmitted from the timer to the second controller so as to terminate any signals from the second controller to the water discharge mechanism such that no further water is discharged from the water discharge mechanism onto the heated platen, while the first controller controls the power delivered to the heating elements of the heated platen so as to permit the heated platen to once again attain the initial temperature level of 400° F. so as to be ready for a new flash-steam cooking cycle. It is lastly noted that in accordance with the aforenoted continuous automatic operation of the controlled system, the only parameter that food equipment personnel need to select is the cooking time by, for example, pushing a START button for the particular item to be cooked which will effectively have the predetermined cooking time cycle built into the system.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic view of a the new and improved control system, constructed in accordance with the principles and teachings of the present invention, for controlling the temperature level of a heated platen in a flash steamer cooking apparatus by controlling the timed discharge of water onto the heated platen; and

FIG. 2 is a graphical representation of the temperature level of a heated platen, as a function of time, for one example of a flash-steaming cooking cycle, wherein it can be seen and appreciated that as the heated platen initially attains a first predetermined temperature level of approximately 400° F. at the beginning of a cooking cycle, as a result of electrical power being supplied to the heating elements of the heated platen in a controlled manner, wherein upon an initial discharge of water being sprayed onto the heated platen, the temperature level of the heated platen drops significantly to a second predetermined temperature level of approximately 300° F. or 350° F., and wherein such temperature level is maintained throughout the cooking cycle as a result of the controlled power delivered to the heating elements of the heated platen, as well as controlled discharges of additional water onto the heated platen, the cyclic water-flash steaming operation will continue until the predetermined programmed cooking time, characteristic of the particular food item being cooked, expires whereby the temperature level of the heated platen will again be permitted to rise in a controlled manner as a result of electrical power being delivered to the heating elements of the heated platen while water is not sprayed onto the heated platen, so as to attain the desired predetermined maximum temperature level characteristic of the beginning of a new cooking cycle.

### DETAILED DESCRIPTION OF THE PREFERRED EMBODIMENT

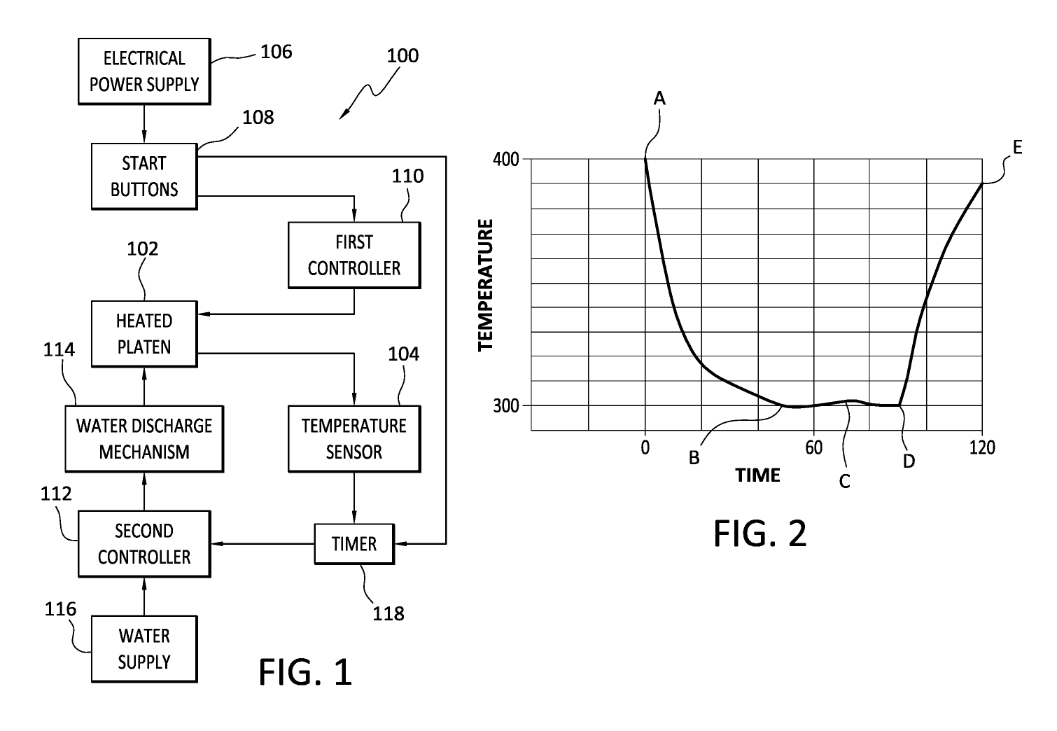

Referring now to the drawings, and more particularly to FIG. 1 thereof, a new and improved system for controlling the temperature level of a heated platen in a flash steamer cooking apparatus, in order to improve the cyclic water-steam operation thereof, is disclosed and is generally indicated by the reference character 100. More particularly, it has been noted that when water is sprayed onto a heated platen 102 which has been heated to a temperature level in excess of 300° F. or 350° F., it is immediately flashed into steam with the adjunct result that the temperature level of the heated platen 102 will be significantly reduced. If the temperature level drops below a predetermined temperature level, such as, for example, 300° F. or 350° F., a sufficient amount of water will not in fact be capable of being flash-steamed whereby, not only will the desired cooking of the food items be compromised but, in addition, the heated platen 102 will effectively be overwhelmed by the water, which is being sprayed onto the heated platen 102 in accordance with a predeterminedly controlled pre-programmed water discharge cycle, and will thereby be flooded so as to no longer be capable of achieving flash-steaming.

Therefore, in accordance then with the principles and teachings of the present invention, the timed discharge of water sprayed onto the heated platen 102 is therefore controlled in accordance with temperature data signals derived from the heated platen 102. The temperature data signals are derived from the heated platen 102 by means of a temperature sensor 104 and are reflective of the thermal energy stored within the heated platen 102 as well as the fact that electrical power is constantly being supplied to the heating elements of the heated platen 102 in a controlled manner, that is, in accordance with a controlled power delivery program, from an electrical power supply 106 so as to heat the same to a predetermined level, such as, for example, 400° F., which is the desired temperature level of the heated platen 102 at the beginning of a flash-steamed cooking cycle when the largest amount of steam to be flashed from the sprayed water is desired in order to rapidly heat the food item and thereby begin cooking the same. Accordingly, at the beginning of a flash-steam cooking cycle, after one of a plurality of START buttons 108 is depressed, wherein the plurality of START buttons 108 respectively represent various different food items to be cooked, electrical power from the electrical power supply 106 will be transmitted to the heating elements of the heated platen 102 through means of a first controller 110 so as to begin heating the heated platen 102. It is to be noted that in lieu of the individual START buttons 108, a Graphical User Interface (GUI) may be provided wherein icons, representing the various different food items, simply need to be touched upon the touch-screen of the Graphical User Interface (GUI). When the temperature sensor 104 senses a temperature level of, for example, 400° F., which, as has been noted, is the desired temperature level of the heated platen 102 at the beginning of a flash-steamed cooking cycle when the largest amount of steam to be flashed from the sprayed water is desired in order to rapidly heat the food item and thereby begin cooking the same, the temperature sensor 104 will transmit a signal to a second controller 112 which is provided in conjunction with a water discharge mechanism 114 for controlling the water discharge mechanism 114 in order to permit the water discharge mechanism 114 to discharge water onto the heated platen 102 in accordance with, for example, a predeterminedly configured sprayed pattern. The second controller 112 is fluidically connected to a suitable water supply 116 for receiving water and permitting the water to be conducted to the water discharge mechanism 114, and the water discharge mechanism 114 may comprise, for example, a direct-acting, spring-biased solenoid controlled valve assembly which opens for an extremely short period of time, as determined by means of a timer 118, in order to spray a predetermined amount of water onto the heated platen 102.

The discharge of the water onto the heated platen 102 will of course tend to reduce the temperature level of the heated platen 102, however, the first controller 110, operatively associated with the heating elements of the heated platen 102, will control the electrical power delivered to the heating elements of the heated platen 102, in accordance with the aforenoted power delivery program, so as to tend to elevate the temperature level of the heated platen to a temperature level of at least 300° F. or 350° F. and thereby ensure that water, discharged from the water discharge mechanism 114 and onto the heated platen 102, will in fact be flash-steamed in order to achieve the complete flash-steaming of the particular food items to be cooked. This temperature level of at least 300° F. or 350° F. is maintained throughout the cooking cycle, which is predeterminedly timed by means of the timer 118, for a particular food item to be cooked, as a result of the first controller 110 tending to constantly elevate the temperature of the heated platen 102 by controlling the amount of electrical power delivered to the heating elements of the heated platen 102, while, at the same time, the second controller 112 controls the water discharge mechanism 114 in order to spray water onto the heated platen 102 in accordance with temperature level signals transmitted from the temperature sensor 104, wherein the water sprayed onto the heated platen 102 will tend to lower the temperature level of the heated platen 102. Accordingly, the end result is that the first and second controllers 110,112 effectively “fight each other” with the first controller 110 controlling the electrical power to the heating elements of the heated platen 102 so as to elevate or raise the temperature level of the heated platen 102 when water is not being discharged by the water discharge mechanism 114 onto the heated platen 102, while the second controller 112 controls the water discharge mechanism 114 which sprays water onto the heated platen 102 which tends to lower or depress the temperature level of the heated platen 102. The ultimate end result is a “stalemate” whereby the temperature level of the heated platen 102 is effectively established at a predeterminedly desired temperature level of, for example, 300° F. or 350° F., as can be graphically appreciated from FIG. 2, so as to ensure that flash-steaming will continue to be achieved throughout the flash-steaming food cooking cycle and without the heated platen 102 being overwhelmed with water and flooded whereby, under such circumstances, the flash-steaming food cooking cycle would be compromised.

Having described substantially all of the components comprising the new and improved control system 100 of the present invention, a brief description of the operation of the control system 100 will now be provided. When one of the START buttons 108 is depressed or otherwise activated so as to begin a food cooking cycle, a signal is effectively sent from the specific START button 108 that was depressed to the timer 118 such that the timer 118 will effectively activate the second controller 112 for a predetermined period of time, which is correlated to the cooking time cycle for the particular food item being cooked as a result of the flash-steaming cooking process, regardless of signals emitted by the temperature sensor 104 and transmitted to the second controller 112 through means of the timer 118. In other words, the timer 118 will control the overall operation of the second controller 112 for a predetermined period of time which correlates to a predetermined cooking time cycle as defined by the particular START button 108 that was depressed. At the conclusion of the timed cooking cycle, the timer 118 will no longer transmit any signals to the second controller 112 whereby no further water will be discharged from the water discharge mechanism 114 onto the heated platen 102, while the first controller 110 controls the electrical power delivered to the heating elements of the heated platen 102, in accordance with a predetermined program or profile so as to permit the heated platen 102 to once again attain the initial temperature level of 400° F. so as to be ready for a new flash-steam cooking cycle. This can be appreciated from the graphical illustration of FIG. 2 wherein, for example, a flash-steaming cooking cycle is commenced at time zero (0), at which time the temperature level of the heated platen 102 is at 400 degrees F. (400° F.) as denoted by A in FIG. 2.

At this time, the temperature sensor 104 will transmit a signal to the timer 118 whereupon the timer 118 will transmit a signal to the second controller 112 so as to, in turn, transmit a signal to the water discharge mechanism 114 in order to, for example, maintain the direct-acting, spring-biased solenoid controlled valve assembly open for an extremely short predetermined period of time so as to discharge a predetermined amount of water onto the heated platen 102, after which the direct-acting, spring-biased solenoid controlled valve assembly is closed so that no more water is discharged from the water discharge mechanism 114 onto the heated platen 102. As a result of such discharge of water onto the heated platen 102, it is seen that the temperature level of the heated platen 102 decreases rapidly to, for example, 300° F., or any other desired predetermined temperature level, as noted at point B in FIG. 2, whereby, as a result of water not being discharged from the water discharge mechanism 114 onto the heated platen 102, the temperature level of the heated platen 102 will tend to rise. However, since the temperature level of the heated platen 102 is at or above the predetermined temperature level of, for example, 300° F., at which flash-steaming can be ensured to occur, a new signal is transmitted from the temperature sensor 104 to the timer 118 such that the timer 118 will issue a new signal to the second controller 112 whereby the second controller 112 will transmit a new signal to the water discharge mechanism 114 such that another predetermined amount of water is discharged from the water discharge mechanism 114 onto the heated platen 102.

It is to be noted that while the amount of water flash-steamed at this stage of the cooking cycle may be less than that flash-steamed at the beginning of the cooking cycle, the amount of water flash-steamed is satisfactory in view of the fact that such lower amount of flashed steam is sufficient to continue and finish the flash steaming of the food product. As can also be appreciated from FIG. 2, this water-flash steam cycle will continue for approximately sixty second (60 sec) or one minute (1 min), as noted at point C in FIG. 2, whereupon the timer 118 will time out, ending the entire cooking cycle as noted at point D in FIG. 2. The timer 118 will therefore not transmit any more signals to the second controller 112, the second controller, in turn, will not transmit any more signals to the water discharge mechanism 114, no further discharges of water will issue from the water discharge mechanism 114 for deposition onto the heated platen 102, and accordingly, the heating elements of the heated platen 102 will again raise or elevate the temperature level of the heated platen 102 to approximately 400° F. as noted at point E in FIG. 2. It is therefore seen and appreciated that the entire cooking cycle lasts approximately two minutes (2 min) from the start of one cooking cycle to the beginning of the next cooking cycle, although, of course, such time periods will vary depending upon the particular food item being cooked. It is therefore to be noted that in accordance with the aforenoted continuous automatic operation of the controlled system 100, the only parameter that food equipment personnel need to select is the cooking time by, for example, pushing the particular START button 108 for the particular item to be cooked which will effectively have the predetermined cooking time cycle built into the system and which will effectively send the predetermined control signal to the timer 118.

Each one of the first and controllers 110,112 may be, for example, a Proportional-Integral-Derivative (PID) controller which is a well-known control loop feedback mechanism which is widely used within various industrial control systems which require continuously modulated control. As is well known, a Proportional-Integral-Derivative (PID) controller continuously calculates an error value as the difference between a desired set point which, in this case is the temperature level of 300° F. or 350° F., below which we do not want the temperature level of the heated platen 102 to fall, and a measured process variable which, in this case is the actual temperature level sensed by the temperature sensor 104, whereby the Proportional-Integral-Derivative (PID) controller 110 applies a correction signal based upon proportional, integral, and derivative terms. In practical terms, it automatically applies accurate and responsive corrections to a control function. An everyday example is the cruise control on an automobile, wherein external influences, such as hills or gradients, normally tend to decrease the speed of the automobile. In such a case, the Proportional-Integral-Derivative (PID) controller algorithm restores the current speed to the desired speed by controlling the power output of the vehicle's engine.

In a similar manner, within the system 100, the second controller 112, upon processing the temperature level data of the heated platen 102 as received from the temperature sensor 104, which data is indicative of the temperature level of the heated platen 102, wherein the temperature level of the heated platen 102 is optimally at least at or above the desired temperature level of at least 300° F. or 350° F. so as to ensure that flash-steaming will occur when water is sprayed onto the heated platen 102, will transmit a signal to the water discharge mechanism 114 so as to open the direct-acting, spring-biased solenoid controlled valve assembly in order to discharge water onto the heated platen 102 whereby the sprayed water will be flashed into steam. It is to be emphasized that the temperature sensor 104 will continuously transmit temperature signals to the second controller 112, however, the second controller 112 will, in turn, send a signal to the water discharge mechanism 114 in order to permit water to be discharged onto the heated platen 102 only when the temperature level of the heated platen 102 is at least at or above the desired temperature level of at least 300° F. or 350° F. so as to ensure that flash-steaming will occur when water is sprayed onto the heated platen 102. In view of the fact that a control signal is transmitted to the water discharge mechanism 114 only when the temperature level of the heated platen 102 is at or above the predeterminedly desired temperature level of 300° F. or 350° F., whereby flash-steaming is effectively guaranteed to be achieved, then the entire cyclic operation is effectively automatically maintained indefinitely, or at least throughout the flash-steaming cooking cycle, whereby flash-steaming will be achieved without the heated platen 102 being overwhelmed by water and becoming flooded whereby flash-steaming would no longer be able to be achieved.

Obviously, many variations and modifications of the present invention are possible in light of the above teachings. It is therefore to be understood that within the scope of the appended claims, the present invention may be practiced otherwise than as specifically described herein.

### REFERENCE NUMBER KEY

100—Control system
102—Heated platen
104—Temperature sensor
106—Electrical power supply
108—START buttons
110—First controller
112—Second controller
114—Water discharge mechanism
116—Water supply
118—Timer
A—Temperature of heated platen at start of cooking cycle
B—Minimum temperature level of heated platen during cooking cycle
C—Relatively constant temperature temperature level during cooking cycle
D—Temperature level of heated platen at end of cooking cycle
E—Temperature level of heated platen at beginning of next cooking cycle

1. A flash steamer water control system for use in connection with flash-steam cooking of food items, comprising:
a heated platen comprising heating elements for heating said heated platen;
an electric power supply for supplying electrical power to said heating elements of said heated platen such that said heating elements of said heated platen can heat said heated platen;
a water discharge mechanism for discharging water onto said heated platen such that water discharged onto said heated platen will be flashed into steam;
a water supply fluidically connected to said water discharge mechanism for supplying water to said water discharge mechanism; and
a control system operatively connected to said water discharge mechanism for controlling said water discharge mechanism so as to permit said water discharge mechanism to discharge water onto said heated platen only when the temperature level of said heated platen is at or above a predetermined temperature level so as to effectively guarantee that the water, discharged from said water discharge mechanism onto said heated platen, will be flashed into steam throughout a predeterminedly timed flash-steamed cooking cycle without overwhelming said heated platen and flooding the same.

2. The system as set forth in claim 1, wherein:
said water discharge mechanism is cyclically activated by said control system throughout said predeterminedly timed flash-steamed cooking cycle.

3. The system as set forth in claim 1, further comprising:
a temperature sensor operatively connected to said heated platen, for receiving first signals from said heated platen which are indicative of said temperature level of said heated platen, and operatively connected to said water discharge mechanism for transmitting second signals to said water discharge mechanism in order to activate said water discharge mechanism such that said water discharge mechanism will only discharge water onto said heated platen when said temperature of said heated platen is at or above said predetermined temperature level.

4. The system as set forth in claim 3, further comprising:
a first controller interposed between said electrical power supply and said heated platen for controlling the amount of electrical power supplied to said heating elements of said heated platen; and
a second controller interposed between said temperature sensor and said water discharge mechanism for controlling the actuation of said water discharge mechanism in accordance with said second temperature signals received from said temperature sensor.

5. The system as set forth in claim 4, wherein:
said first and second controllers respectively control the amount of electrical power supplied to said heating elements of said heated platen, and the actuation of said water discharge mechanism, such that the temperature of said heated platen will remain substantially constant, throughout said flash-steam cooking cycle, at said predetermined temperature level as a result of said first and second controllers respectively controlling the amount of electrical power supplied to said heating elements of said heated platen and the actuation of said water discharge mechanism.

6. The system as set forth in claim 4, wherein:
a timer is interposed between said temperature sensor and said second controller so as to establish a predetermined time period for said flash-steam cooking cycle.

7. The system as set forth in claim 6, further comprising:
a plurality of buttons wherein each one of said plurality of buttons is operatively connected to said timer and is specifically dedicated or correlated to a particular food item to be flash-steam cooked whereupon activation of a particular one of said plurality of buttons, said timer will automatically establish the predetermined time period for said flash-steam cooking cycle appropriate for the particular food item.

8. The system as set forth in claim 7, wherein:
said activation of any one of said plurality of buttons is the only act need to be performed by food personnel in order to actuate said system so as to permit said system to perform a flash-steam cooking cycle.

9. The system as set forth in claim 4, wherein:
said first and second controllers are Proportional-Integral-Derivative (PID) controllers.

10. Flash steamer cooking apparatus, for the flash-steam cooking of food items, having a water control system incorporated therein comprising:
a heated platen comprising heating elements for heating said heated platen;
an electric power supply for supplying electrical power to said heating elements of said heated platen such that said heating elements of said heated platen can heat said heated platen;
a water discharge mechanism for discharging water onto said heated platen such that water discharged onto said heated platen will be flashed into steam;
a water supply fluidically connected to said water discharge mechanism for supplying water to said water discharge mechanism; and
a control system operatively connected to said water discharge mechanism for controlling said water discharge mechanism so as to permit said water discharge mechanism to discharge water onto said heated platen only when the temperature level of said heated platen is at or above a predetermined temperature level so as to effectively guarantee that the water, discharged from said water discharge mechanism onto said heated platen, will be flashed into steam throughout a predeterminedly timed flash-steamed cooking cycle without overwhelming said heated platen and flooding the same.

11. The system as set forth in claim 10, wherein:
said water discharge mechanism is cyclically activated by said control system throughout said predeterminedly timed flash-steamed cooking cycle.

12. The system as set forth in claim 10, further comprising:
a temperature sensor operatively connected to said heated platen, for receiving first signals from said heated platen which are indicative of said temperature level of said heated platen, and operatively connected to said water discharge mechanism for transmitting second signals to said water discharge mechanism in order to activate said water discharge mechanism such that said water discharge mechanism will only discharge water onto said heated platen when said temperature of said heated platen is at or above said predetermined temperature level.

13. The system as set forth in claim 12, further comprising:
a first controller interposed between said electrical power supply and said heated platen for controlling the amount of electrical power supplied to said heating elements of said heated platen; and
a second controller interposed between said temperature sensor and said water discharge mechanism for controlling the actuation of said water discharge mechanism in accordance with said second temperature signals received from said temperature sensor.

14. The system as set forth in claim 13, wherein:
said first and second controllers, respectively control the amount of electrical power supplied to said heating elements of said heated platen, and the actuation of said water discharge mechanism, such that the temperature of said heated platen will remain substantially constant, throughout said flash-steam cooking cycle, at said predetermined temperature level as a result of said first and second controllers respectively controlling the amount of electrical power supplied to said heating elements of said heated platen and the actuation of said water discharge mechanism.

15. The system as set forth in claim 13, wherein:
a timer is interposed between said temperature sensor and said second controller so as to establish a predetermined time period for said flash-steam cooking cycle.

16. The system as set forth in claim 15, further comprising:
a plurality of buttons wherein each one of said plurality of buttons is operatively connected to said timer and is specifically dedicated or correlated to a particular food item to be flash-steam cooked, whereupon activation of a particular one of said plurality of buttons, said timer will automatically establish the predetermined time period for said flash-steam cooking cycle appropriate for the particular food item.

17. The system as set forth in claim 16, wherein:
said activation of any one of said plurality of buttons is the only act need to be performed by food personnel in order to actuate said system so as to permit said system to perform a flash-steam cooking cycle.

18. The system as set forth in claim 13, wherein:
said first and second controllers are Proportional-Integral-Derivative (PID) controllers.
